(19) United States
(12) Patent Application Publication
(10) Pub. No.: US 2026/0069949 A1
(43) Pub. Date: Mar. 12, 2026

(54) TOUCH SENSITIVE JUGGLING APPARATUS

(71) Applicant: JD Clemon Lee Meredith, Adamsville, TN (US)

(72) Inventor: JD Clemon Lee Meredith, Adamsville, TN (US)

(21) Appl. No.: 19/324,840

(22) Filed: Sep. 10, 2025

Related U.S. Application Data
(60) Provisional application No. 63/693,387, filed on Sep. 11, 2024.

(51) Int. Cl. A63B 67/08

(52) U.S. Cl. CPC A63B 67/08; A63B 2225/74

(57) ABSTRACT

An exemplary interactive device and method are disclosed that electronically tracks the manipulation of the device by a person and guides via visual or sensory feedback to the person their performance in juggling or manipulating that device, e.g., as a teaching or reinforcement tool for the person to learn or practice juggling or for enhancing a performance in relation to that device. The exemplary method allows the exemplary device to be fabricated having a center of mass conducive for juggling and consistent or repeatable manipulation. The exemplary device is configured to receive and track programmable inputs from the user to adjust the visual or sensory feedback and to adjust the mode of operation for play or performance.

### RELATED APPLICATION

This U.S. patent application claims priority to, and the benefit of, U.S. Provisional Patent Application No. 63/693,387, filed Sep. 11, 2024, entitled “TOUCH SENSITIVE JUGGLING APPARATUS,” which is incorporated by reference herein in its entirety.

### BACKGROUND

Juggling is the physical act of manipulating an object or multiple objects for entertainment, sport, or art. One of the most common and recognizable types of juggling is toss juggling, which involves a performer, i.e., a juggler, tossing an object or multiple objects into the air and catching those objects as they fall back down. The juggler will then toss the caught objects back into the air and repeat as many times as desired. Some common juggling objects include balls, rings, hoops, and clubs or pins, but juggling is not necessarily limited to a certain type of object. More extreme performers may toss and juggle with knives or other bladed objects. Another type of juggling is cigar box juggling, where the juggler takes a handheld cigar box in each hand and uses the two boxes to toss and flip a third box in between. Yet another type of juggling is performed with a diabolo, a prop with an axle and two cups, which prop is spun on its axle using a string attached to two sticks on each end of the string. A juggler can spin and toss the diabolo on the string to perform tricks and can even spin multiple diabolos on the same string.

Disclosed herein is an improvement to juggling.

### SUMMARY

An exemplary interactive device and method are disclosed that electronically tracks the manipulation of the device by a person and guides via visual or sensory feedback to the person of their performance in juggling or manipulating that device, e.g., as a teaching or reinforcement tool for the person to learn or practice juggling or for enhancing a performance in relation to that device. The exemplary fabrication and manufacturing method allows the exemplary device to be fabricated with internal components that provide, with the object, a center of mass conducive for juggling and consistent or repeatable manipulation. The exemplary device is configured to receive and track programmable inputs from the user to adjust the visual or sensory feedback and to adjust the mode of operation for play or performance.

Jugglers and aspiring jugglers throughout history have learned to juggle from a variety of sources, often from personal or class instructors but also from guidebooks or videos. Aspiring jugglers without the luxury of an in-person instructor to learn from, may need to refer to guidebooks and videos to learn and practice the skill by themselves. Absent the guidance of an instructor, it may be difficult to critique one's own form and method or to keep track of the number of catches of an object a juggler achieves in a practice session. The juggling apparatus disclosed herein can provide and store certain information related to one's own practice session so that a juggler or aspiring juggler can refer to that information during or after a practice session in order to improve their juggling even without the presence of an instructor.

In an aspect, a juggling apparatus is disclosed as having an object that forms a shell, the shell having both an inside and outside surface, respectively, to define a volume therein. Embedded on or beneath the shell surface are one or more capacitive touch sensors configured to capacitively touch and create a measured capacitance signal in response. Also embedded on or beneath the shell surface is one or more light-emitting diode (LED). The apparatus further includes a controller assembly, having a controller and housing. The controller is configured such that it can (i) receive the measured capacitance signal provided by the capacitive touch sensors, (ii) track the number of touches or contacts the juggling object receives, and (iii) directing output to the LEDs based on the tracked number of touches or contacts the juggling object receives. The housing encompasses the controller, together creating the controller assembly. The housing is fixably coupled to an energy storage device, such as a battery. The controller assembly altogether has a single center or mass with or without a counterweight. In this aspect, the controller assembly is fixably positioned inside the volume of the shell such that the center of mass of the controller assembly and the center of mass of the apparatus are at or near one another, ideally sharing the same position in space.

In some embodiments, the shell has a form factor of a ball or another juggable object. Such juggable objects may include, but are not limited to, any of a juggling ring, juggling club, juggling cigar boxes, or a diabolo. Aspiring jugglers will often use such-shaped objects to practice juggling. Upon becoming more practiced with such-shaped objects, an aspiring juggler may want to then use other irregularly shaped objects to practice on.

In some embodiments, the shell is a unitary, rigid structure that will not change at any time. An aspiring juggler may find more ease in practicing with objects that maintain structural consistency and do not deform subject to external pressures that occur in toss juggling, such as hand-held contact or shifts in momentum due to gravity. In other embodiments, the shell is either an internal rigid or flexible substrate, which is then coupled to an external deformable encapsulation, such as foam or other deformable, cushioning materials. In further embodiments, the shell is a flexible membrane that will deform in response to contact. Examples of these embodiments are not limited to hand-held pillows, beanbags, anthropomorphic/polymorphic shapes, or even water-ballon-like objects.

In some embodiments, embedding on or beneath the shell is at least one output actuator, such as a piezoelectric actuator, being electronically connected to the controller. In this embodiment, the piezoelectric actuator is configured to mechanically vibrate or produce a sound in response to the directed output from the controller based on the tracked number of touches or contacts the juggling object receives. An aspiring juggler may be working in an environment, such as a bright day outdoors, where visual LED lighting alone may not entirely suffice for keeping track of the number of touches alongside the device. In such an instance, this embodiment allows for additional ways for an aspiring juggler to keep track, either by sound or by haptic feedback produced by the piezoelectric actuator, the number of touches or contacts, the number of throws during a practice session or performance.

In some embodiments, the controller is configured to receive input for a first control mode. In this first control mode, the controller outputs a signal to a single LED or a combination of multiple LEDs, which causes the LED(s) to light up or flash for a pre-defined time period upon each instance of receiving a measured capacitance signal from the capacitive touch sensors. In this embodiment, an aspiring juggler can visually track, alongside the device, the number of touches or contacts made with the object(s) during a practice session or performance.

In some embodiments, the controller is configured to receive input for a second control mode. In this second control mode, the controller outputs a signal to a single actuator or a combination of multiple actuators, which causes the actuator(s) to produce a mechanical vibration or a sound, for a pre-defined time period upon each instance of receiving a measured capacitance signal from the capacitive touch sensors. In this embodiment, an aspiring juggler can track, via haptic feedback or audio cues, alongside the device, the number of touches or contacts made with the object(s) during a practice session or performance.

In some embodiments, the controller is configured to receive input for a third control mode. In this third control mode, the controller detects a control sequence upon input that allows the user of the device to select among various lengths of pre-defined time periods that are used as the pre-defined time periods in the first and second control modes, respectively. An aspiring juggler may desire the length of time that the LED(s) are lit up to be longer time or shorter time for upon each instance of the controller receiving a measured capacitance signal from the capacitive touch sensors during a practice session. In this embodiment, an aspiring juggler has the option to adjust the time period that the LED(s) are lit to coordinate timely with the tosses during a practice session or in a performance to an audience. In this same embodiment, an aspiring juggler can also adjust the duration of time that the actuator(s) produce a sound or vibration. The LED turn-on time may be delayed, as an additional setting, to allow the user to time/adjust the action of the LED, e.g., during the crest of a throw.

In some embodiments, the controller is configured to receive input for a fourth control mode. In this fourth control mode, the controller detects a control sequence upon input that allows the user of the device to toggle through various pre-defined display and output settings of the device. For example, the user can toggle on or off either haptic feedback or sound produced by the actuator if those features are not desired during a practice session or performance. The user can also toggle through various pre-defined settings, such as LED and IR LED color output combinations, to adjust them according to the environment, mood, or music of a practice session or performance. The IR LED may be used for communication, e.g., to coordinate operations, as outputs or inputs, with another device.

In some embodiments, the controller is configured to detect a control sequence based on receiving a measured capacitance signal for a pre-defined time. For example, the device may currently be set to light up the LEDs for one second upon being the object caught. A user can adjust the device by tapping, tapping, and holding, or double tapping a programming capacitive touch sensor, such that the controller will detect a different control sequence that is configured to light up the LEDs for half of one second upon the object being caught. In this embodiment, an aspiring juggler can select among pre-set modes of operation of the device.

In some embodiments, for example, when the shell has the shape of a ball, the center of mass of the controller assembly is at the center of mass of the apparatus, such that the centers of mass of each of the controller assembly and apparatus are shared. In this embodiment, the trajectory of each juggled object is more easily determined to help the aspiring juggler practice.

In some embodiments, for example, when the shell has the shape of a juggling club or pin, the center of mass of the controller assembly is near the center of mass of the apparatus, such that the centers of mass of each of the controller assembly and apparatus are effectively shared. In this embodiment, the trajectory of each juggled object is more easily determined to help the aspiring juggler practice.

In some embodiments, for example, when the shell has the shape of a diabolo or juggling ring, the apparatus also includes a counterweight. The center of mass of the controller is in one position in the volume defined by the shell, and the counterweight is placed at a second position within the volume, such that the combined center of mass of the controller and counterweight is in the same spatial position as the center of mass of the apparatus. In this embodiment, the trajectory of each juggled object is more easily determined to help the aspiring juggler practice.

In some embodiments, the apparatus is used for training jugglers or aspiring jugglers. The controller has a separate mode for training or practice, which a user can toggle on or off via prolonged touch or series of touches to the programming capacitive touch sensor. In this embodiment, a user can set the LED(s) and actuator(s) to settings that are conducive to practicing juggling, such as flashing a certain color to indicate a certain number of catches.

In some embodiments, the apparatus is used for a performance for an audience. The controller has a separate mode for performance, which a user can toggle on or off via prolonged touch or series of touches to the programming capacitive touch sensor. In this embodiment, a user can set the LED(s) and actuator(s) to settings that are conducive to a juggling performance, such as flashing different colors every toss or in other visually appealing ways.

In some embodiments, the apparatus is used for a solo-player game or group game. The controller has a separate mode for games, which a user can toggle on or off via prolonged touch or series of touches to the programming capacitive touch sensor. In this embodiment, a user can set the LED(s) and actuator(s) to settings that are conducive to a juggling game, such as flashing a certain color to denote that it is a player's turn to juggle in a game, or flashing a certain sequence of colors to show that a new record-setting number of touches—a high score—has been achieved.

In another aspect, a method is disclosed for forming an object for the juggling apparatus, the object having a shell with inside and outside surfaces, respectively, to define a volume therein. Capacitive touch sensors configured to capacitively touch and create a measured capacitance signal in response are mounted on or beneath the shell. One or more LEDs are also mounted on or beneath the shell. Further mounted in the shell is a controller assembly, having a controller and housing. The controller is configured such that it can (i) receive the measured capacitance signal provided by the capacitive touch sensors, (ii) track the number of touches or contacts the juggling object receives, and (iii) directing output to the LEDs based on the tracked number of touches or contacts the juggling object receives. The housing is fixably coupled to an energy storage device, such as a battery. The controller assembly altogether has a single center or mass with or without a counterweight. In this aspect, the controller assembly is fixably positioned inside the volume of the shell such that the center of mass of the controller assembly and the center of mass of the apparatus are at or near one another, ideally sharing the same position in space.

In some embodiments, the shell is formed by the process of rotational molding, which can allow for unique shapes of shells to be formed multiple times while only requiring one mold for each shape.

### BRIEF DESCRIPTION OF THE FIGURES

FIG. 1 shows an exemplary apparatus having a shell mounted with sensors and LEDs. Within the shell is a controller assembly which allows for communication between the sensors and output LEDs. The same apparatus is also shown where the shell has the form factor of a ball. As can be seen in the figure, the center of mass of the controller assembly and the center of mass of the apparatus overlap one another.

FIG. 2 shows an example of how the capacitive touch sensors communicate with the controller assembly. The capacitive touch sensors can register the touch or contact made with the outer surface of the shell, create a measured capacitance signal in response, which is then relayed to the controller assembly for further processing.

FIG. 3 shows the controller assembly being inserted into a specially designed slot on an energy storage device—in this case, a battery—which controller assembly and energy storage device are together enclosed within a casing that is secured by a lid fixed into place with a screw.

FIG. 4 the controller assembly, having been coupled to the energy storage device and housing, mounted into the shell of the object so that object, shell, controller assembly and energy storage device, all effectively function as one single unit.

FIGS. 5A-5C each shows an example juggling apparatus the volume defined by the shell is in a different form factor. FIG. 5A shows the form factor of a club or pin. FIG. 5B shows the form factor of a cigar box. FIG. 5C shows another example of the form factor of a cigar box with the addition of a structural support column.

FIGS. 6A-6C describe a method to manufacture the juggling apparatus.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Example System

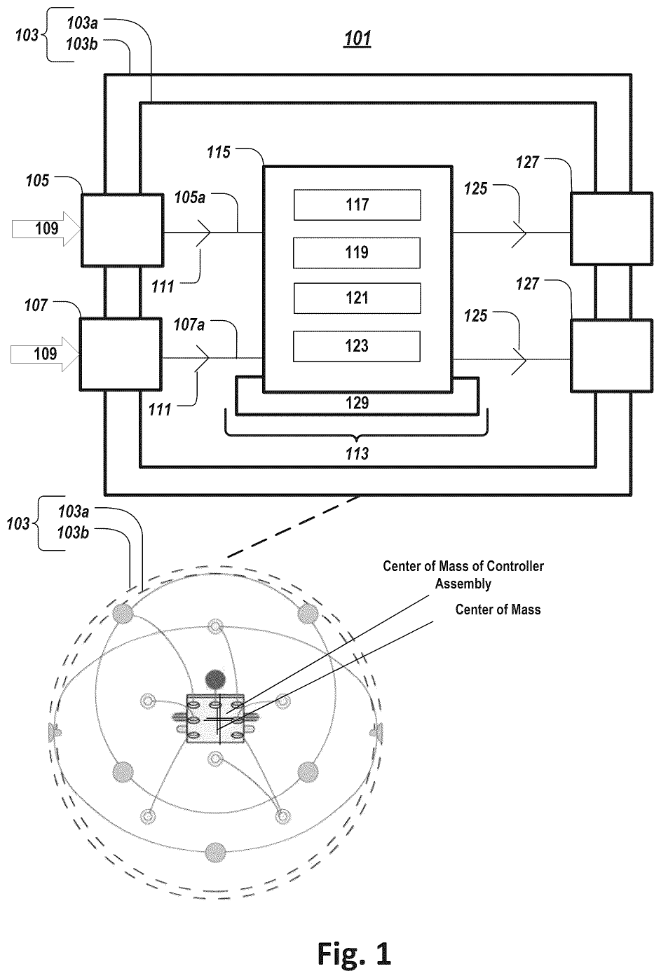

FIG. 1 shows a juggling apparatus 100 to be used as a tool for jugglers or aspiring jugglers. The juggling apparatus 100 includes an object that forms a shell 102, the shell 102 having inside surface 102a and outside surface 102b, which together define a volume therein. The shell 102 and resulting volume together can have the form factor of a ball, a juggling ring, a juggling club, a juggling cigar box, a diabolo, or another juggling-able object. In certain embodiments, the material from which shell 102 is made is rigid and inflexible, such that the distance between the inside surface 102a and outside surface 102b cannot change. In yet other embodiments, the material from which shell 102 is made is flexible and soft, such that the distance between inside surface 102a and outside surface 102b can change according to pressures applied to either of the surfaces.

In the example shown in FIG. 1, embedded in several possible locations on or beneath the shell 102, penetrating through at least the inside surface 102a, is at least one touch sensor node 104 and at least one programming touch sensor node 106. Touch sensor node 104 and programming touch sensor node 106 are each configured to receive an input 108 of capacitive touch and provide a measured capacitance signal 110 in response. The touch sensor node 104 provides inputs to the apparatus to determine when the juggler picks up, catches, touches the object, or a combination thereof. The programming touch sensor node 106 provides input to the controller to select among pre-set modes of display of the apparatus or alternatively to create a mode of display. Modes of display refer to the arrangement, sequences, and patterns of flashes being output from at least one light-emitting diode (LED) 126. The measured capacitance signal 110 is relayed via transfer wires 104a and 106a from touch sensor node 104 and programming touch sensor node 106, respectively, to controller 116 inside the controller assembly 112.

Controller assembly 112, contained entirely within the inside surface 102a of the shell, is composed of a housing 114 enclosing controller 116, electric circuit 118, network interface 120, and, in certain embodiments, piezoelectric actuator 122. Controller 116 is configured to receive the measured capacitance signal 110, track and store a number of touch or contacts, and then, based on the tracked and stored information, direct an output signal 124 to at least one LED 126. LEDs 126, which can either be infrared (IR) LEDs 126a or red, blue, and green (RBG) LEDs 126b, can be placed within the controller assembly or can alternatively be embedded on or beneath the shell 102.

Electric circuit 118 electronically couples the controller 116 to each of the touch sensor node 104 and programming touch sensor node 106 and also to LEDs 126. Network interface 120 allows for both a wireless transfer of the capacitance signal 110, eliminating the need for transfer wires 104a and 106a, and allows for wireless transfer of the input 108 data for recording in external devices or servers. In certain embodiments, the controller assembly 112 is further composed of a piezoelectric actuator 122 electronically coupled to the controller 116, which can produce a vibration in response to an output signal 124 received from the controller 116. The controller assembly 112 is designed to be fixed into a seat in the energy storage device 128 designed specifically for the controller assembly 112, whereby the energy storage device 128 not only provides power the controller assembly 112 but also whereby the relative positions of the energy storage device 128 and controller assembly 112 to one another become fixed. In certain embodiments, the controller assembly 112 has a center of mass that is fixed in position with the volume of the shell 102 such that the juggling apparatus 100 ideally shares the same center of mass as the controller assembly 112. In other embodiments, the controller assembly 112 and the energy storage device 128 together share a center of mass that is fixed in position with the volume of the shell 102 such that the juggling apparatus 100 ideally shares the same center of mass as the controller assembly and the energy storage device 128 together.

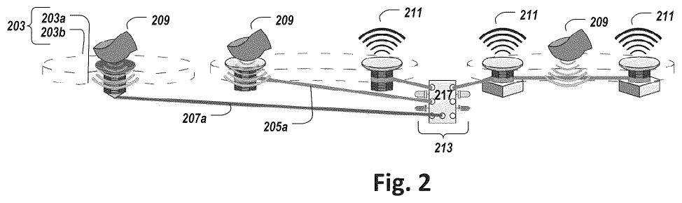

Touch sensor. FIG. 2 shows examples of touch sensor nodes 204 and 206 receiving an input 208 of capacitive touch and producing measured capacitance signal 210. On the far left, a person touches the outside surface 202b, where programming touch sensor node 206 directly receives the touch as input 208. The input 208 signal travels along transfer wire 206a to the controller assembly 212, where controller 216 can interpret the input 208 signal to select the desired mode of display. In the middle section, a person touches the outside surface 202b, where touch sensor nodes 204 receive the input 208 signal. The touch sensor nodes 204 that received the input 208 produce a capacitance signal 210 in response, which capacitance signal 210 then travels along transfer wire 204a to the controller assembly 212, where controller 216 can interpret the measured capacitance signal 210 and then direct output signal 224 to the LEDs 226 to produce a flash or sequence of flashes. The touch input 208 can occur anywhere on the outside surface 202b, including directly upon a sensor, as shown in the middle section of FIG. 2, or in between two sensors, as shown in the far-right section of FIG. 2. Because the touch sensor nodes 204 are configured to receive inputs 208 of capacitive touch, the sensors themselves do not need to be touched directly nor applied direct pressures. In certain embodiments, transfer wires 204a and 206a can be eliminated, such the input 208 and measured capacitance signals 210 can be transferred to the controller wirelessly via a network interface.

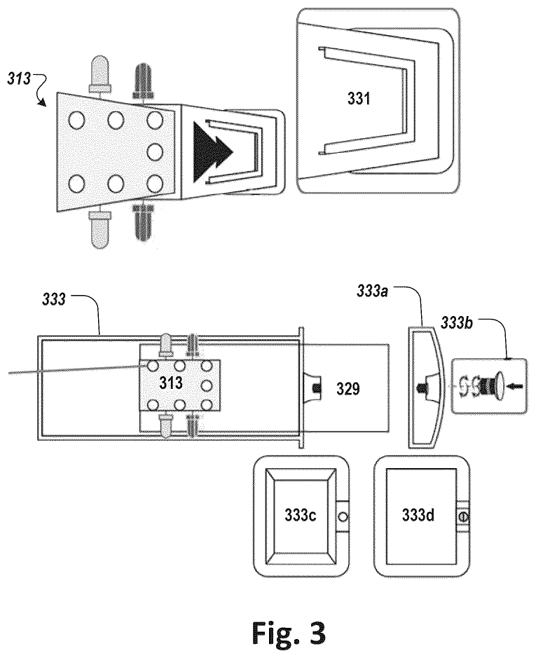

Controller assembly. FIG. 3 shows the controller assembly 312 (previously shown as 112) being attached to energy storage device 328. In the top section, controller assembly 312 is mounted into a specially designed slot 330 on the energy storage device 328, which will not only fix the two pieces together but also allow for the powering of the controller assembly 312 by the energy storage device 328. In the middle section, energy storage device 328, combined with controller assembly 312, is then inserted into an energy storage device case 332, which includes a case lid 332a fastened into place by case lid screw 332b. The center of mass of the controller assembly 312 and the center of mass of the energy storage device 328 are positionally fixed relative to one another such that the combined controller assembly 312 and energy storage device 328 share a single center of mass. The bottom section shows the top views 332c and 332d of the energy storage device case 332 when the case lid has not yet been fastened (332c) by case lid screw 332b and when the case lid has been fastened (332d) by the case lid screw 332b, respectively.

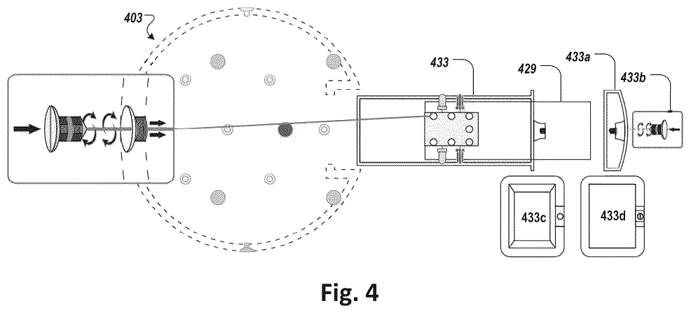

Energy storage device. FIG. 4 shows the assembly of the energy storage device 428, encased in the energy storage device case 432, sealed by the case lid 432a fastened by case lid screw 432b, all being inserted into the shell 502, in this case having a form factor of a juggling ball. The energy storage device case 432 can slide into the shell until posts jutting out of the side of the energy storage device case 432 near the case lid 432a come into contact with the shell 402 to prevent further insertion. The case lid 432a is shaped such that the outside surface 402b of the shell 402, when the energy storage device 428 and case lid 432a are inserted, completes the intended form factor of the shell. In this embodiment, because the form factor is that of a juggling ball, the outer surface of the case lid 432a must be curved to match the curvature of the ball.

Examples of these embodiments are not limited to hand-held pillows, beanbags, anthropomorphic or polymorphic shapes, as well water-ballon-like objects.

### Example Apparatus Configuration

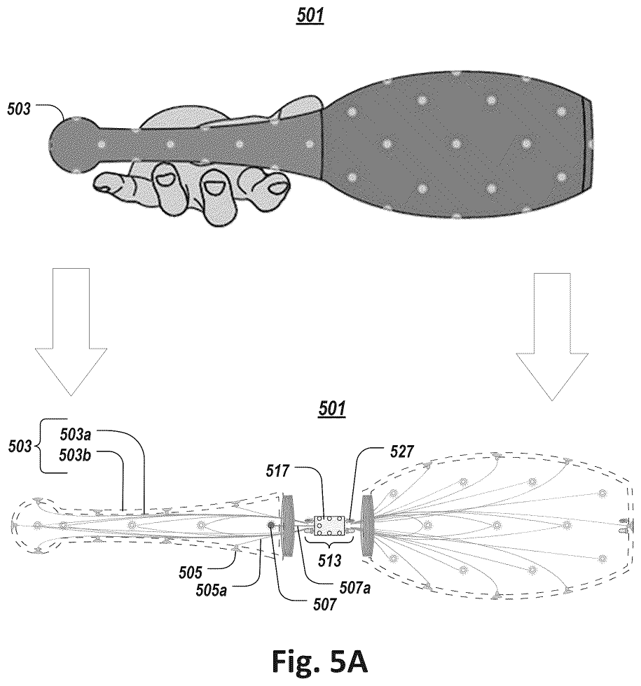

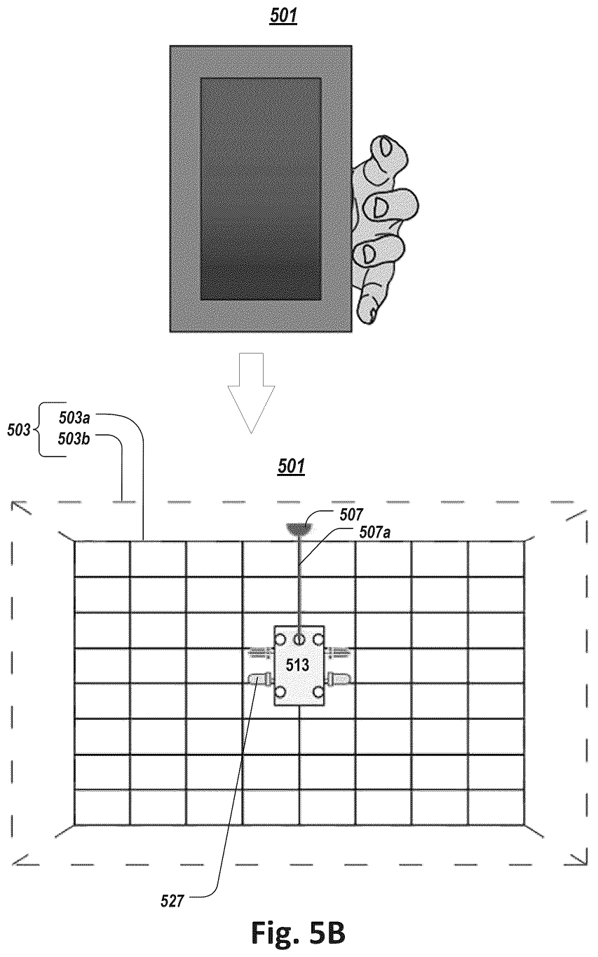

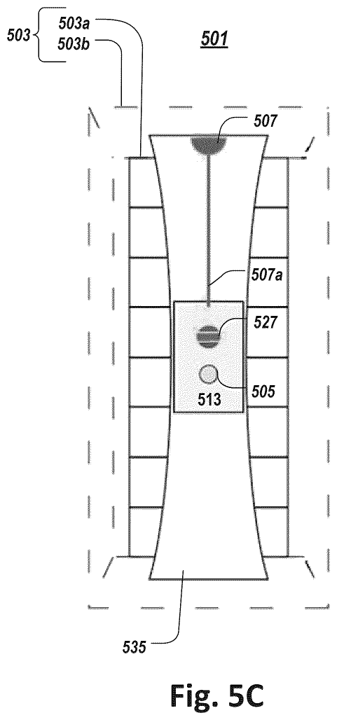

FIGS. 5A-5C each shows an example juggling apparatus 100 (shown as 500a, 500b, 500c) configured to electronically track the manipulation of the device by a person and guides via visual or sensory feedback to the person of their performance in juggling or manipulating that device.

In the example shown in FIG. 5A, the juggling apparatus 500 includes shell 502 form factor of a juggling club. The top section of FIG. 5A shows the club being separated by color into a handle section and a pin section. When the two sections are combined, the center of mass of the juggling club is at the junction which separates the two sections. The bottom section of FIG. 5A shows a transparent, partially exploded view of the juggling apparatus 500 as a whole. The shell 502 has inside surface 502a and outside surface 502b, the controller assembly 512 has controller 516 attached to various touch sensor nodes 504 via transfer wires 504a and attached to a programming touch sensor node 506 via transfer wire 506a. LEDs 526 are further shown included in the controller assembly 512 and disposed along the inside surface 502 of the pin section of the club.

FIG. 5B shows the juggling apparatus 500 having the shell 502 form factor of a juggling cigar box. The top section of FIG. 5B shows the apparatus when viewed externally. The bottom section of FIG. 5B shows a mesh-drawn view of the juggling apparatus 500, where the controller assembly 512, including LEDs 526, is centered in the apparatus and attached to programming touch sensor node 506 via transfer wire 506a.

FIG. 5C shows a transparent, side view of the juggling apparatus 500 having the shell 502 form factor of a juggling cigar box. The controller assembly 512 includes a touch sensor node 204, at least one LED 526, and a transfer wire 506a connecting to programming touch sensor node 506. In this embodiment, the controller assembly 512 is fixably attached to a molded post 534 within the cigar box. The molded post 534 helps not only the structural integrity of the cigar box but also allows for a rigid structure that the controller assembly 512 may be fixed to such that the controller assembly 512 and overall juggling apparatus 500 share the same location of center of mass.

To fabricate the exemplary device to have a center of mass conducive for juggling and consistent or repeatable manipulation, the components, which are non-uniform have to be integrated to provide the correct feel for juggling.

### State Machine Operation for Controller

Built into the controller of the apparatus is a system of receiving and tracking programmable inputs from the user to adjust the visual or sensory feedback.

By touching the capacitive sensor denoted by color for a few seconds, the controller would allow the user to program the first set of the object parameters. If the user holds longer then a set amount of time, the controller would enter the programming of the other parameters. The user can touch the capacitive sensor denoted by color for longer amounts of time to enter different parameters that can be individually programmed with Double Taps and Single Taps. The threshold operation in the interface and associated controls allows the minimum number of input IO for the device, which reduce the likelihood of the device being inadvertently changed in its programming during use.

After the initial threshold operation, the controller can accept inputs based on held duration (HD), double tap (DT), or single tap (ST) to provide encoded input to the device. Tables 1A-1D provide a list of example operations for the programming.

TABLE 1A
Set 1: HD These instructions may apply to All
RGB LEDs the first time it is held or touched.

| | |
|---|---|
| Subset 1: | The color that occurs when not being held or touched. |
| DT | Select: ST - Colors/Strobe |
| Subset 2: | The color that occurs when being held or touched. |
| DT | Select: ST - Colors/Strobe |
| Subset 3: | The color that occurs when flashing. |
| DT | Select: ST - Colors |

TABLE 1B
Set 2: HD These instructions may apply to All
RGB LEDs the second time it is held or touched.

| | |
|---|---|
| Subset 1: | The color that occurs when not being held or touched. |
| DT | Select: ST - Colors/Strobe |
| Subset 2: | The color that occurs when being held or touched. |
| DT | Select: ST - Colors/Strobe |
| Subset 3: | The color that occurs when_ashing. |
| DT | Selects: ST - Colors |

TABLE 1C
Set 3: HD These instructions may apply to HALF of
the RGB LEDs the first time it is held or touched.

| | |
|---|---|
| Subset 1: | The color that occurs when not being held or touched. |
| DT | Select: ST - Colors/Strobe |
| Subset 2: | The color that occurs when being held or touched. |
| DT | Select: ST - Colors/Strobe |
| Subset 3: | The color that occurs when_ashing. |
| DT | Select: ST - Colors |

TABLE 1D
Set 3: HD These instructions may apply to HALF of
the RGB LEDs the second time it is held or touched.

| | |
|---|---|
| Subset 1: | The color that occurs when not being held or touched. |
| DT | Select: ST - Colors/Strobe |
| Subset 2: | The color that occurs when being held or touched. |
| DT | Select: ST - Colors/Strobe |
| Subset 3: | The color that occurs when_ashing. |
| DT | Select: ST - Colors |

The construction and arrangement of the systems and methods, as shown in the various implementations, are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementation of the present disclosure may be implemented using computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a microprocessor, microcontroller, special purpose computer, or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

### Example Manufacturing

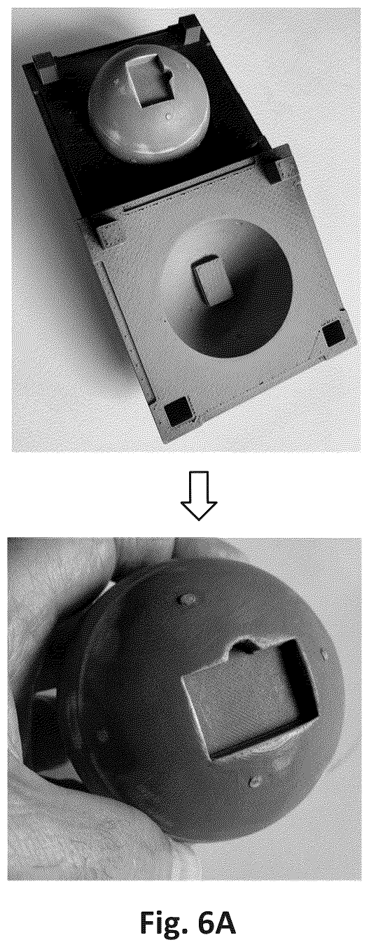

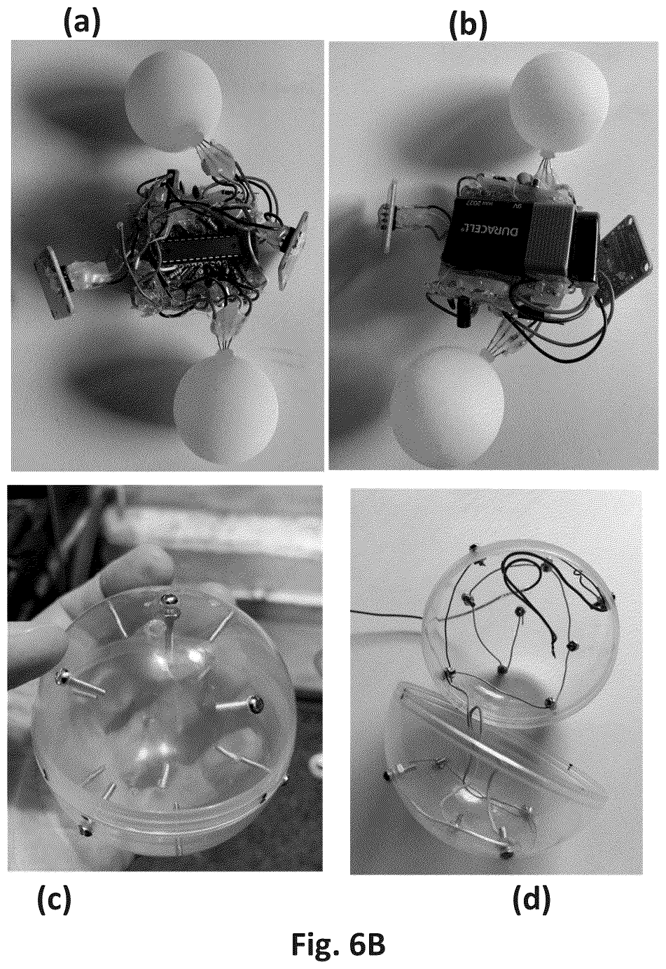

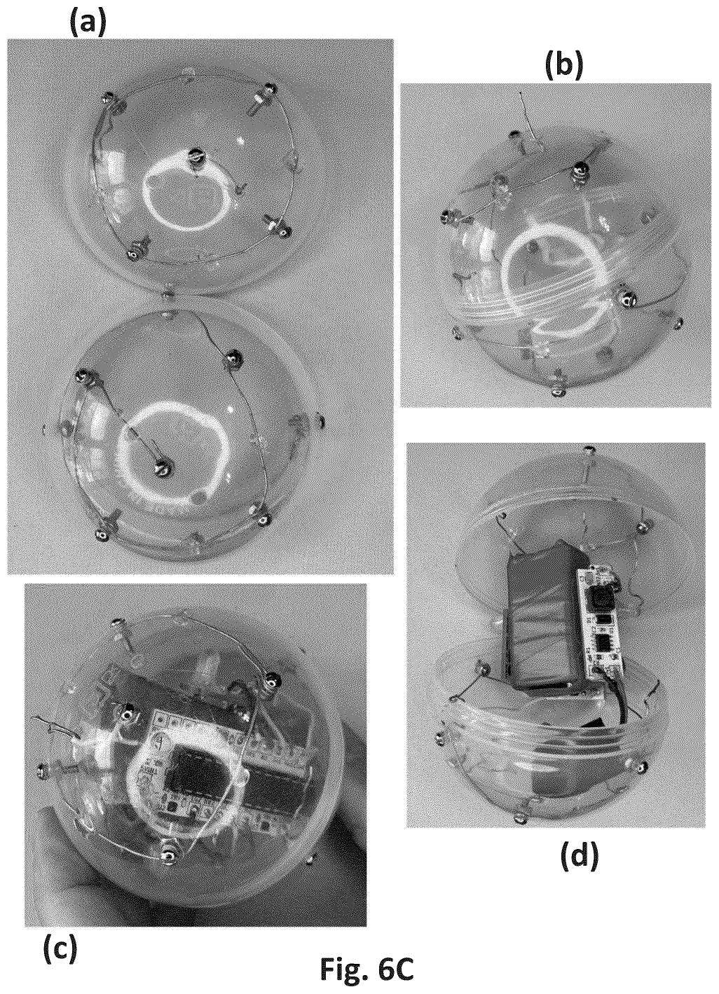

FIGS. 6A-6C are shown to provide a visual description of the steps of manufacturing the juggling apparatus. The juggling apparatus may be made by using rotational molding to allow for a mold that has several equally separated partially threaded stems that point to the inside of the juggling apparatus so to have a negative spaces from the stems. This is so when removed from the mold the negative spaces can receive the sensors by being screwed in with an adhesive for maximum stability and can be housed and attached to the controller assembly that will be placed inside the shell.

FIG. 6A shows an example of the rotational molding mold and corresponding apparatus. In some embodiments, the apparatus can be rotomolded with areas to hold screws so to be able to create a threading in the surface the capacitive sensors to attach.

FIG. 6B shows an example the controller of the apparatus in the top of the figure and an example of the shell of the apparatus in the bottom of the figure to house the controller.

FIG. 6C shows another example of construction of the apparatus. Shown as subpanel (a) of FIG. 6C are two halves of an outer shell fabricated from a soft, deformable, nonconductive material selected for its low dielectric interference with capacitive sensing, such as silicone rubber or polyurethane. The thickness of the outer shell is optimized at a level to both permit capacitive signal transmission and withstand repeated physical impact that can occur during operation.

Embedded throughout the outer shell is a plurality capacitive sensor nodes being flush with or slightly recessed beneath the inner surface of the outer shell. The nodes are arranged equidistant from a central structural core shown in subpanels (c) and (d) of FIG. 6C. A radial wiring layout implementing flexible printed circuits, stretchable conductive inks, slack looped wire paths, or combinations thereof, electrically connects the central structural core to each respective node in a spoke-like pattern to ensure uniform signal timing, balanced mechanical force distribution, and reliable touch detection over the outer surface of the shell. Further, the flexible connections between sensor nodes and the central structural core allow for deformation of the core during operation without mechanically straining the connections, reducing fatigue on the connections and increasing the longevity of the apparatus.

The central structural core, shown in subpanels (c) and (d) of FIG. 6C, is formed of shock-absorbing material such as ethylene-vinyl-acetate foam, thermoplastic elastomer, or rubberized polymer, to house the primary electronic components, the controller having a microprocessor, the power source such as a lithium polymer battery, and the sensor node interface circuitry. The central structural core is configured to fit within the geometric center of the apparatus, aligned with the apparatus' center of mass such that a consistent balance is maintained during operation. The central core is further suspended inside the shell of the apparatus by a system of radial supports or molded flexural arms that can be embedded in the shell's inner surface, attached directly to the central core, or both, to achieve isolation of the central core during operation, even upon deformation of the outer shell upon impact. The suspension of the central core provides a gap between the electronics and the outer shell, which functions as a mechanical buffer to absorb energy and protect components from impact damage.

Balance and weight distribution of the apparatus is critical for feasible use in juggling. As such, all components, respective to one another, are arranged to maintain the center of mass of the apparatus at its geometric center. The positioning of the central structural core within the geometric center of the apparatus contributes to the proper balance and weight distribution. Other methods, usable in isolation or conjunction with the positioning of the central structural core, include usage of counterweights, mass-matched modules, or free-floating media to ensure consistent handling across multiple identical units. In some embodiments, free-floating media, such as small, plastic, translucent stability beads can be included within internal compartments or sealed cavities within the shell of the apparatus in order to contribute to fine tuning of mass, promote internal damping of impact to components during operation, or optionally provide aesthetic or tactile feedback.

When all components have been assembled, mounted, and connected, the outer shell can be sealed together around the core, such as in subpanels (b) and (d) of FIG. 6C. Based on the material used to construct the apparatus, sealing can be achieved through either overmolding, ultrasonic welding, or adhesive bonding to produce a weather-resistant, durable, structurally integrated apparatus.

In some instances a more rigid resin is used such as in with cigar boxes, juggling clubs and juggling rings in where a mesh must be placed through a planned opening such as where the battery unit or consequently the controller assembly will go. Also in the instance of having to rely on rigid resin using rotational molding several equally separated divots that can hold the sensors by using a week adhesive that can withstand the pressures of the rotation to holden place the equally separated sensors but will release after mold is pulled apart leaving the sensors embedded in the juggling apparatus.

In other instances a deformable or soft structure may need conductive patches or conductive thread to conform to the shape of the soft juggling apparatus and can be attached by sewing to the outside or inside of the juggling apparatus with the controller assembly within the juggling apparatus.

The method of construction described results in a throwable electronic apparatus capable of detecting user interaction via capacitive touch, maintaining structural and electrical integrity during drops, and providing consistent balance and responsiveness during juggling or dynamic manipulation. The method of construction ensures long-term durability and precision across multiple identical units.

### CONCLUSION

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification.

While the methods and systems have been described in connection with certain embodiments and specific examples, it is not intended that the scope be limited to the particular embodiments set forth, as the embodiments herein are intended in all respects to be illustrative rather than restrictive.

In this specification and in the claims that follow, reference will be made to a number of terms, which shall be defined to have the following meanings:

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a compound”, “a composition”, or “a cancer”, includes, but is not limited to, two or more such compounds, compositions, or cancers, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Throughout this application, various publications may have been referenced. The disclosures of these publications in their entireties are hereby incorporated by reference into this application in order to more fully describe the state of the art to which this invention pertains.

What is claimed is:

1. A juggling apparatus comprising:
an object that forms a shell having an inside surface and an outside surface to define a volume therein;
a plurality of sensors disposed on or at the shell, including a first sensor disposed at a first location and a second sensor disposed at a second location, wherein the first sensor and the second sensor are each configured to capacitively touch or contact and provide a measured capacitance signal;
a plurality of light emitting diodes disposed on or at the shell at a plurality of locations on or at the shell; and
a controller assembly comprising a housing and a controller, the controller being configured to (i) receive the measured capacitance signal, the controller being configured, (ii) track a number of touch or contact, and (iii) direct output to the plurality of light emitting diodes based on the tracked number of touch or contact
wherein the housing is fixably coupled to an energy storage device, and wherein the controller assembly has a center of mass with or without a counterweight, the controller assembly being fixably positioned within the volume of the shell such that the center of mass of the controller assembly with or without the counterweight is at or near a center of mass of the apparatus.

2. The juggling apparatus of claim 1, wherein the shell has a form factor of a ball, a juggling ring hoop, a juggling club or a bowling pin, a juggling cigar box, or a Chinese yo-yo/Diabolo.

3. The juggling apparatus of claim 1, wherein the shell is a unitary rigid structure.

4. The juggling apparatus of claim 1, wherein the shell comprises either (i) an internal rigid or flexible substrate coupled to an external deformable encapsulation (e.g., foam) or (ii) a flexible membrane.

5. The juggling apparatus of claim 1 further comprising:
one or more output actuators, the one or more output actuators being electronically connected to the controller to mechanically vibrate or output a sound.

6. The juggling apparatus of claim 1, where in the controller is configured to:
receive an input for a control mode;
in the control mode, for each measured capacitance signal, output a signal to the plurality of light emitting diodes for a pre-defined time period.

7. The juggling apparatus of claim 5, where in the controller is configured to:
receive an input for a second control mode;
in the second control mode, for each measured capacitance signal, output a signal to the one or more output actuators for a pre-defined time period.

8. The juggling apparatus of claim 6, where in the controller is configured to:
receive an input for a third control mode;
in the third control mode, for a control sequence detected at the input, toggling through the pre-defined time period.

9. The juggling apparatus of claim 6, where in the controller is configured to:
receive an input for a fourth control mode;
in the fourth control mode, for a control sequence detected at the input, toggling through the pre-defined setting.

10. The juggling apparatus of claim 8, wherein the controller is configured to detect an input based on a measured capacitance signal for a pre-defined time, the controller being configured to detect a first control sequence, a second control sequence, and a third control sequence.

11. The juggling apparatus of claim 1, wherein the center of mass of the controller assembly is at the center mass of the apparatus.

12. The juggling apparatus of claim 1, wherein the center of mass of the controller assembly is near the center mass of the apparatus.

13. The juggling apparatus of claim 1 further comprising:
a counterweight,
wherein the controller assembly is positioned in a first position in the volume, and wherein the counterweight is positioned in a second position in the volume, wherein the center of the controller assembly with the counterweight is at the center of mass of the apparatus.

14. The juggling apparatus of claim 1, wherein the apparatus is used for juggling training, the controller having a control mode for training.

15. The juggling apparatus of claim 1, wherein the apparatus is used for a juggling performance, the controller having a control mode for performance.

16. The juggling apparatus of claim 1, wherein the apparatus is used for a game, the controller having a control mode for a game.

17. A method comprising:
forming an object for a juggling apparatus, the object having a shell having an inside surface and an outside surface to define a volume therein;
mounting a plurality of sensors on or at the shell, including a first sensor disposed at a first location and a second sensor disposed at a second location, wherein the first sensor and the second sensor are each configured to capacitively touch or contact and provide a measured capacitance signal;
mounting a plurality of light emitting diodes disposed on or at the shell at a plurality of locations of the shell; and
mounting a controller assembly comprising a housing and a controller in the shell, the controller being configured to (i) receive the measured capacitance signal, the controller being configured (by instructions or electric circuit), (ii) track a number of touch or contact, and (iii) direct output to the plurality of light emitting diodes based on the tracked number of touch or contact,
wherein the housing is fixably coupled to an energy storage device, and wherein the controller assembly has a center of mass, and wherein the controller assembly is fixably positioned within the volume of the shell at or near a center of mass of the apparatus.

18. The method of claim 17, wherein the object is formed by roto-molding.
